(19) United States
(12) Patent Application Publication
(10) Pub. No.: US 2011/0004720 A1
(43) Pub. Date: Jan. 6, 2011

(54) METHOD AND APPARATUS FOR PERFORMING FULL RANGE RANDOM WRITING ON A NON-VOLATILE MEMORY

(76) Inventors: Chun-Ying Chiang, Chiayi City (TW); Ping-Sheng Chen, Hsinchu County (TW)

Correspondence Address: NORTH AMERICA INTELLECTUAL PROPERTY CORPORATION, P.O. BOX 506, MERRIFIELD, VA, 22116, US

(21) Appl. No.: 12/496,660

(22) Filed: Jul. 2, 2009

(51) Int. Cl. G06F 12/00; G06F 12/02; G06F 12/10

(52) U.S. Cl. 711/103; 711/206; 711/E12.001; 711/E12.008; 711/E12.059

(57) ABSTRACT

A method for performing random writing on a NV memory includes: writing page mapping information regarding a portion of a full range of addresses of the NV memory and providing at least one page mapping table corresponding to a predetermined size; and accessing the NV memory according to the page mapping information. An apparatus for performing full range random writing on an NV memory includes: a controller arranged to perform the full range random writing; and a program code, at least a portion of which is embedded within the controller or received from outside the controller. The controller executing the program code writes page mapping information regarding at least a portion of a full range of addresses of the NV memory and provides at least one page mapping table corresponding to a predetermined size. The controller executing the program code accesses the NV memory according to the page mapping information.

### BACKGROUND

The present invention relates to solid state drives (SSDs), and more particularly, to a method and an apparatus for performing full range random writing on a non-volatile (NV) memory such as a Flash memory.

Flash memories have been widely applied to portable storage devices. For example, most memory cards on the market, such as those complying with Compact Flash (CF) standards or Secure Digital (SD) standards, or the derivatives thereof, are typically implemented with Flash memories.

According to the related art, Flash memories can be utilized for implementing SSDs. Compared to hard disk drives (HDDs), the storage capacity of SSDs implemented with Flash memories are quite limited due to characteristics of the Flash memories. As laptop computers launched for specific purposes of use require less storage capacity than those for general purposes, some laptop computers on the market are equipped with SSDs, instead of HDDs.

In practice, Flash memories should be erased in units of blocks, rather than bytes. In addition, Flash memories are typically written in units of pages. As a result, when implementing SSDs with Flash memories, delicate data access control is required in order to emulate access control such as that in HDDs. Traditional methods of data access control of SSDs implemented with Flash memories require a large buffer size, causing high costs and end prices. Thus, a novel method is required for reducing the costs without degrading the performance of the SSDs.

### SUMMARY

It is therefore an objective of the claimed invention to provide a method and an apparatus for performing random writing on a non-volatile (NV) memory, in order to solve the above-mentioned problem.

An exemplary embodiment of a method for performing random writing on an NV memory comprises: writing page mapping information regarding a portion of a full range of addresses of the NV memory and providing at least one page mapping table corresponding to a predetermined size, wherein the page mapping information represents at least a relationship between a logical page number and a physical page number; and accessing the NV memory according to at least a portion of the page mapping information.

An exemplary embodiment of an apparatus for performing random writing on an NV memory comprises: a controller arranged to perform the random writing; and a program code, at least a portion of which is embedded within the controller or received from outside the controller; wherein the controller executing the program code writes page mapping information regarding a portion of a full range of addresses of the NV memory and provides, within one of the apparatus and the NV memory, at least one page mapping table corresponding to a predetermined size, wherein the page mapping information represents at least a relationship between a logical page number and a physical page number; and the controller executing the program code accesses the NV memory according to at least a portion of the page mapping information.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of an apparatus for performing full range random writing on a non-volatile (NV) memory according to a first embodiment of the present invention.

FIG. 2 is a flowchart of a method for performing full range random writing on an NV memory according to one embodiment of the present invention.

FIG. 3 illustrates an example of a block mapping table according to one embodiment of the present invention.

FIG. 4 illustrates an example of a block pointer table according to the embodiment shown in FIG. 3.

FIG. 5 illustrates an example of a random write page mapping table according to the embodiment shown in FIG. 3.

FIG. 6 illustrates examples of link chain page mapping tables according to the embodiment shown in FIG. 3.

FIG. 7 illustrates an example of a free link pointer entry table according to the embodiment shown in FIG. 3.

FIG. 8 illustrates an example of a local page mapping table and associated mapping relationships according to another embodiment of the present invention.

FIG. 9 illustrates an example of a plurality of latest page indexes embedded in a block mapping table and associated mapping relationships according to the embodiment shown in FIG. 8.

FIG. 10 illustrates an example of a writing mode switching scheme and associated mapping relationships according to the embodiment shown in FIG. 8.

FIG. 11 illustrates an example of a plurality of latest page indexes embedded in a block mapping table and an associated LPMT table that may be positioned in one or more LPMT table blocks according to a variation of the embodiment shown in FIG. 8.

FIG. 12 illustrates an example of a page-link structure and associated mapping relationships according to another embodiment of the present invention.

FIG. 13 illustrates an example of a plurality of latest page indexes embedded in a block mapping table and associated mapping relationships according to the embodiment shown in FIG. 12.

### DETAILED DESCRIPTION

Certain terms are used throughout the following description and claims, which refer to particular components. As one skilled in the art will appreciate, electronic equipment manufacturers may refer to a component by different names. This document does not intend to distinguish between components that differ in name but not in function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

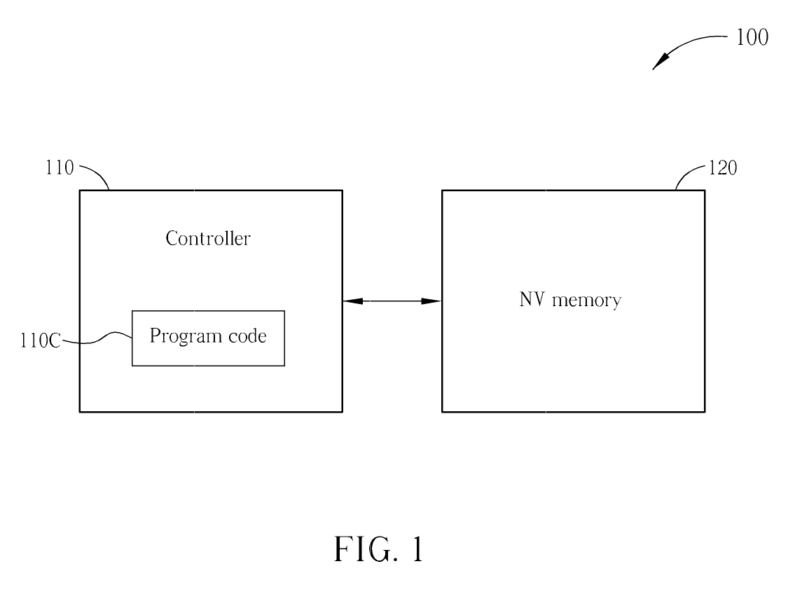

Please refer to FIG. 1, which illustrates a diagram of an apparatus 100 for performing random writing on a non-volatile (NV) memory 120 such as a Flash memory according to a first embodiment of the present invention. In this embodiment, the apparatus 100 is a solid state drive (SSD) comprising the NV memory 120, where the NV memory 120 is positioned within the SSD. This is for illustrative purposes only, and is not meant to be a limitation of the present invention. According to a variation of this embodiment, the NV memory 120 is positioned outside the apparatus 100. According to another variation of this embodiment, the apparatus 100 can be a memory card, such as that complying with Compact Flash (CF) standards or Secure Digital (SD) standards.

As shown in FIG. 1, the apparatus 100 comprises a controller 110 arranged to perform the random writing, and further comprises a program code 110C embedded within the controller 110. In this embodiment, the program code 110C is a hardware code such as a read only memory (ROM) code. This is for illustrative purposes only, and is not meant to be a limitation of the present invention. According to a variation of this embodiment, the program code 110C can be received from outside the controller 110, instead of being embedded within the controller 110. For example, the controller 110 is a micro processing unit (MPU), where the program code 110C is a software code. In another example, the controller 110 is a micro control unit (MCU), where the program code 110C is a firmware code.

According to another variation of this embodiment, at least a portion of the program code 110C is embedded within the controller 110 or received from outside the controller 110. For example, a portion of the program code 110C is embedded within the controller 110, while another portion of the program code 110C is received from outside the controller 110.

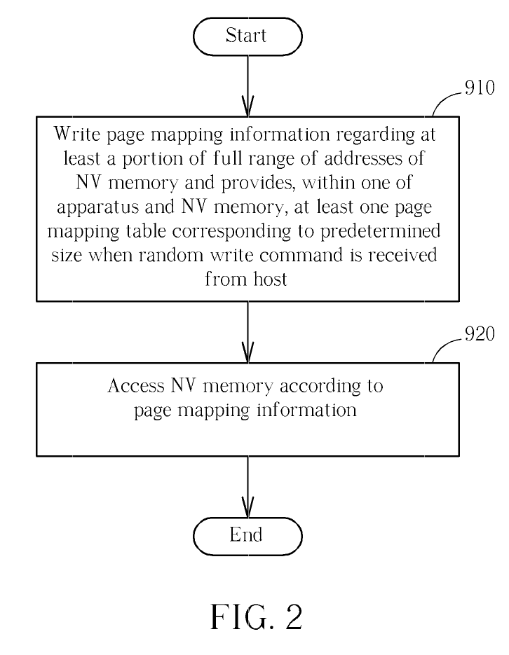

According to this embodiment, the controller 110 executing the program code 110C writes page mapping information regarding at least a portion of a full range of addresses of the NV memory 120 when a random write command is received from a host (not shown) coupled or electrically connected to the apparatus 100. In particular, the controller 110 executing the program code 110C writes page mapping information regarding the full range of addresses of the NV memory 120 when a random write command is received from the host. Detailed operations of the controller 110 can be described by referring to FIG. 2.

FIG. 2 is a flowchart of a method for performing random writing on an NV memory according to one embodiment of the present invention. The method shown in FIG. 2 can be applied to the apparatus 100, and more particularly, to the controller 110 executing the program code 110C mentioned above. In addition, the method shown in FIG. 2 can be implemented by utilizing the apparatus 100, and more particularly, by the controller 110 executing the program code 110C mentioned above. The method is described as follows.

In Step 910, the controller 110 executing the program code 110C writes page mapping information regarding at least a portion of a full range of addresses of the NV memory 120 and provides, within one of the apparatus 100 and the NV memory 120, at least one page mapping table corresponding to a predetermined size (e.g. a predetermined storage volume such as a plurality of bytes, a plurality of kilobytes, a plurality of megabytes, a plurality of gigabytes, etc.) when a random write command is received from the host. In this embodiment, the page mapping information represents at least a relationship between a logical page number and a physical page number.

In practice, when the random write command is received from the host, the controller 110 executing the program code 110C can selectively write the page mapping information in the NV memory 120 and/or a volatile memory, such as a dynamic random access memory (DRAM) or a static random access memory (SRAM). For example, the DRAM or the SRAM is positioned within the apparatus 100. This is for illustrative purposes only, and is not meant to be a limitation of the present invention. According to a variation of this embodiment, the DRAM or the SRAM is positioned outside the apparatus 100. According to another variation of this embodiment, the volatile memory mentioned above is positioned within the controller 110.

According to another variation of this embodiment, the controller 110 executing the program code 110C writes the page mapping information in the NV memory 120 when the random write command is received from the host, where the apparatus 100 is not equipped with the volatile memory mentioned above. According to another variation of this embodiment, the controller 110 executing the program code 110C typically writes the page mapping information in the NV memory 120 when the random write command is received from the host, where the apparatus 100 is equipped with the volatile memory mentioned above. According to another variation of this embodiment, the controller 110 executing the program code 110C typically writes the page mapping information in the volatile memory mentioned above (e.g. the DRAM or the SRAM). In another embodiment, the controller 110 executing the program code 110C typically compress or encodes the page mapping information, and then stores the compressed or encoded page mapping information into the NV memory.

In Step 920, the controller 110 executing the program code 110C accesses the NV memory 120 according to at least a portion of the page mapping information (e.g. a portion of the page mapping information, or all of the page mapping information). For example, in a situation where the page mapping information (or a portion thereof) is in the NV memory 120, the controller 110 executing the program code 110C may read out the page mapping information (or the portion thereof) and access data in the NV memory 120 according to the page mapping information read from the NV memory 120 (or the portion thereof). In another example, in a situation where the page mapping information (or a portion thereof) is temporarily stored in the volatile memory mentioned above (e.g. the DRAM or the SRAM), the controller 110 executing the program code 110C accesses data in the NV memory 120 according to the page mapping information temporarily stored in the volatile memory (or the portion thereof).

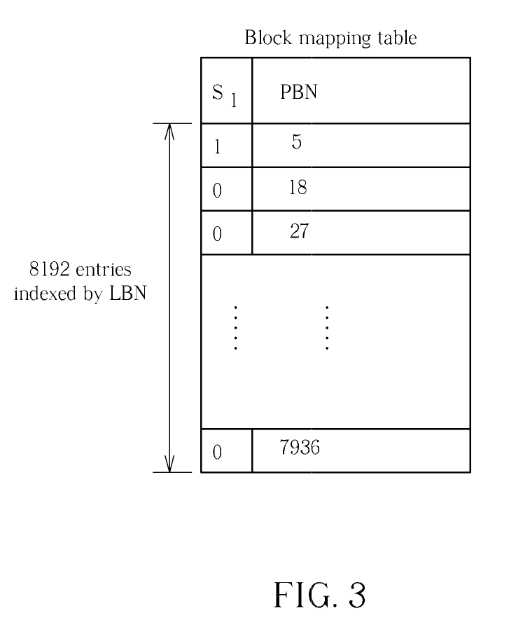

FIG. 3 illustrates an example of a block mapping table according to one embodiment of the present invention, where this embodiment is a special case of the embodiment shown in FIG. 2. The page mapping information of this embodiment comprises at least one block mapping table such as that shown in FIG. 3, at least one block pointer table, and at least one random write page mapping table.

In this embodiment, entries of the block mapping table, such as the 8192 entries {(1, 5), (0, 18), (0, 27), . . . , (0, 7936) shown in FIG. 3, are indexed by logical block numbers (LBNs). The block mapping table represents respective relationships between LBNs and physical block numbers (PBNs) of the NV memory 120, where the flag S₁ is utilized for indicating whether random write data exists in the associated block. For example, a logical value “1” of the flag S₁ represents that random write data exists in the associated block, and a logical value “0” of the flag S₁ represents that random write data does not exist in the associated block. This is for illustrative purposes only, and is not meant to be a limitation of the present invention. According to a variation of this embodiment, the logical value “0” of the flag S₁ represents that random write data exists in the associated block, and the logical value “1” of the flag S₁ represents that random write data does not exist in the associated block.

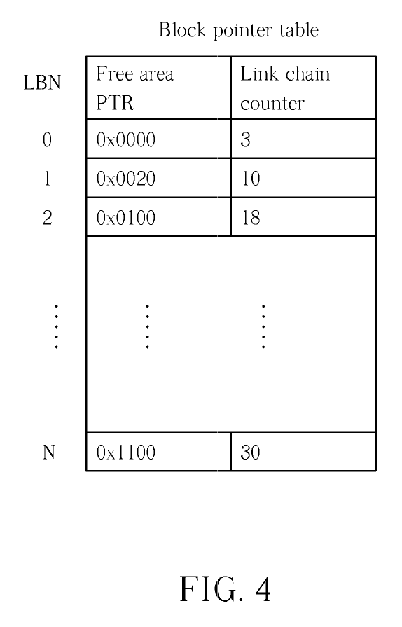

FIG. 4 illustrates an example of the block pointer table according to the embodiment shown in FIG. 3, where the block pointer table is indexed by LBNs. The first column “Free area PTR” represents pointers pointing to respective portions of a free area, and the second column “Link chain counter” indicates entry counts of link chains respectively starting from the associated portions of the free area as pointed to by the pointers in the first column. For example, the first entry of the block pointer table, i.e. (0x0000, 3), represents that there is a link chain starting from the address 0x0000 with the entry count of this link chain being 3. For example, in one or more free areas, pages of the same block are linked together to form one of the link chains. In another example, in one or more free areas, pages of the same group block (which is a unit representing a group of blocks) are linked together to form one of the link chains.

In particular, a pointer in the first column “Free area PTR” can be utilized for pointing to a next entry, and an entry count in the second column “Link chain counter” can be utilized for triggering a merging operation. For example, when the entry count of a link chain reaches a predetermined threshold value, the controller 110 can start the merging operation, where the associated pointer in the first column “Free area PTR” is utilized for tracing the next entry in the link chain.

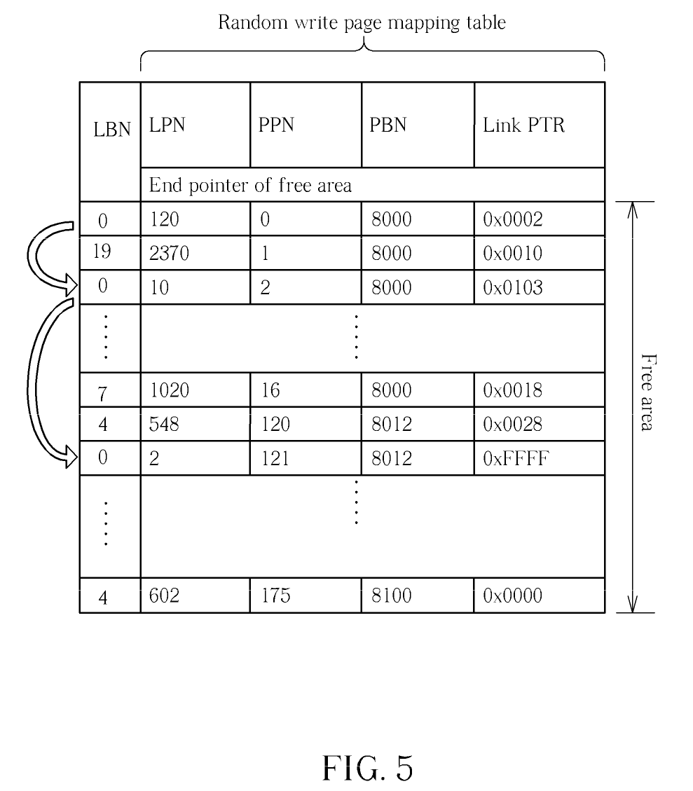

FIG. 5 illustrates an example of the random write page mapping table according to the embodiment shown in FIG. 3. In this embodiment, the column “LBN” is not a portion of the random write page mapping table since an LBN can be calculated according to a logical page number (LPN). For example, given that each logical block has 128 logical pages, an LBN corresponding to a LPN is equal to a quotient derived from dividing the LPN by 128, with the remainder being omitted.

According to this embodiment, each entry of the random write page mapping table comprises information indicating whether a next entry exists or information indicating where the next entry is. Taking the first entry of the random write page mapping table as an example, the LPN of 120 maps to a physical page number (PPN) of 0 within a physical block having a PBN of 8000. According to the first entry of the block pointer table shown in FIG. 4, there is a link chain starting from an entry located at the row entry address 0x0000, i.e. the link chain starting from the first entry of the random write page mapping table. Here, the row entry address 0x0000 represents the beginning location of the free area shown in FIG. 5.

Please note that the last column “Link PTR” is utilized for indicating whether a next entry exists or indicating where the next entry is. Regarding the first entry, the pointer in the last column “Link PTR” is 0x0002, which means the next entry (i.e. the second entry of this link chain) is located at the row entry address 0x0002. Similarly, regarding the second entry, the pointer in the last column “Link PTR” is 0x0103, which means the next entry (i.e. the third entry of this link chain) is located at the row entry address 0x0103. Regarding the third entry, the pointer in the last column “Link PTR” is 0xFFFF, which is a predetermined value for indicating that there is no next entry: that is, the third entry is the last entry of this link chain.

The controller 110 of this embodiment writes the random write page mapping table entry by entry during random writing, where each entry corresponds to a page. As a result, in the free area, entries are linked into link chains. By utilizing the random write page mapping table, the controller 110 is capable of merging entries according to the link chains. For example, the random write page mapping table is written for a block, and the controller 110 merges entries of the same block according to the link chains. In another example, the random write page mapping table is written for a group block, and the controller 110 merges entries of the same group block according to the link chains.

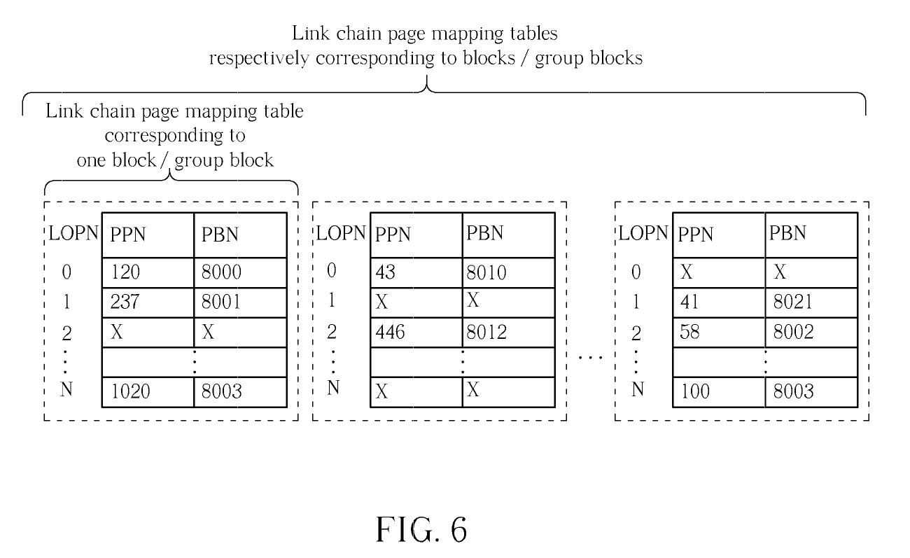

FIG. 6 illustrates examples of link chain page mapping tables according to the embodiment shown in FIG. 3, where the notation “X” in these link chain page mapping tables stands for “Don't care”, which means there is no existence of the page corresponding to the associated PPN and PBN. In practice, the notation “X” in these link chain page mapping tables can be implemented with one or more predetermined values dedicated to the purpose of indicating the meaning “Don't care”.

As a result of merging entries of the same block/group block according to the link chains, the link chain page mapping tables respectively corresponding to blocks/group blocks are formed. More particularly, each link chain page mapping table corresponding to one block/group block is indexed by LOPNS (Logical offset page number). LOPN is offset page number within every block. As the controller 110 executing the program code 110C is capable of writing random write page mapping tables such as that shown in FIG. 5 entry by entry during random writing, the controller 110 can convert the random write page mapping tables into the link chain page mapping tables shown in FIG. 6 in a time-efficient manner, rather than finding each entry of each block throughout the NV memory 120. Therefore, the controller 110 can easily merge random write data into sequential write data and access the NV memory 120 rapidly.

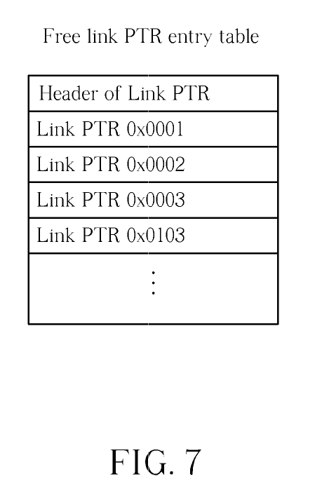

FIG. 7 illustrates an example of a free link pointer entry table according to the embodiment shown in FIG. 3. In this embodiment, the number of entries in the free link pointer entry table (labeled “Free Link PTR entry table”) is equal to a value defined in the header of Link pointers (labeled “Header of Link PTR”).

According to this embodiment, each of the entries in the free link pointer entry table is a link pointer (labeled “Link PTR” followed by an associated address) for indicating which portion of a free area is freed from use. More particularly, the associated address of the link pointer mentioned above (e.g. 0x0001, 0x0002, 0x0003, or 0x0103) is an offset value with respect to the free area. By utilizing at least one free link pointer entry table such as that shown in FIG. 7, empty entries of one or more free areas can be easily recycled. Therefore, the controller 110 is capable of managing the free area(s) in a time-efficient manner.

According to some variations of the embodiment shown in FIG. 2. the controller executing the program code can selectively write at least a portion of the page mapping information in one or more pages of at least one block of the NV memory according to some other pages of the block. For example, the portion of the page mapping information comprises a local page mapping table regarding one or more random mapping zones (each of which comprises at least one block), where the controller executing the program code selectively writes/caches one or more entries of the local page mapping table in the volatile memory mentioned above. In another example, the portion of the page mapping information comprises a page-link structure regarding one or more random mapping zones (each of which comprises at least one block), where the controller executing the program code selectively writes/caches one or more entries of the page-link structure in the volatile memory mentioned above.

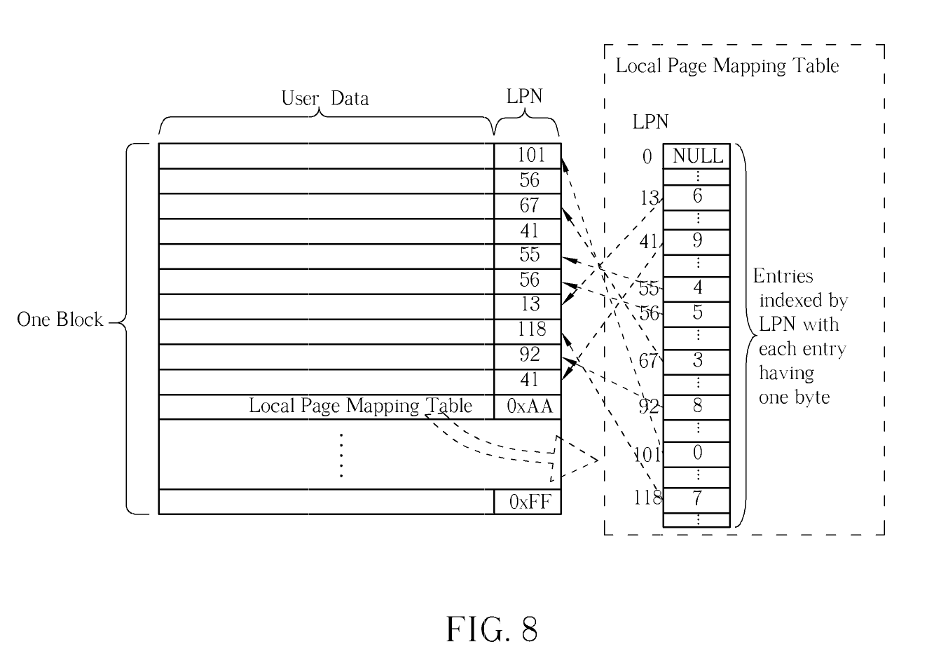

FIG. 8 illustrates an example of a local page mapping table and associated mapping relationships according to another embodiment of the present invention, where this embodiment is a special case of the embodiment shown in FIG. 2. The page mapping information of this embodiment comprises at least one local page mapping table regarding one random mapping zone, such as the local page mapping table shown in FIG. 8. This is for illustrative purposes only, and is not meant to be a limitation of the present invention. According to a variation of this embodiment, the page mapping information comprises at least one local page mapping table regarding two or more random mapping zones.

According to this embodiment, the controller 110 writes the block shown in FIG. 8 entry by entry during random writing, where each entry corresponds to a page. As a result, the user data stored in each entry is followed by an associated LPN. As mentioned, the controller 110 is capable of selectively writing the page mapping information in the NV memory 120 or the volatile memory (e.g. the DRAM or the SRAM). More particularly, in this embodiment, the controller 110 can write the local page mapping table in the volatile memory first, and then update the local page mapping table in the volatile memory, and further write the local page mapping table in the NV memory 120 when needed.

Please note that the volatile memory of this embodiment is utilized as a local page mapping table buffer, which can be simply referred to as the LPMT buffer. The controller 110 temporarily stores one or more local page mapping tables in the LPMT buffer according to the mapping relationships between the PPNs and the LPNs, and updates each local page mapping table in the LPMT buffer during random writing, where each random mapping zone has at least one block and has its own local page mapping table. When the volatile memory is full or is determined to be not utilized as the LPMT buffer during a period, the controller 110 writes each local page mapping table into the NV memory 120, and more particularly, the latest page of the associated random mapping zone.

As a result, in a situation where the controller 110 needs the local page mapping table of a specific random mapping zone and cannot find the local page mapping table throughout the volatile memory (e.g. the DRAM or the SRAM), the controller 110 may just read the latest page of the specific random mapping zone to obtain the local page mapping table of the specific random mapping zone. Taking the random mapping zone comprising the at least one block shown in FIG. 8 as an example, given that the controller 110 has written the local page mapping table in the latest page of this random mapping zone, the controller 110 may simply read the local page mapping table from the latest page of this random mapping zone, in order to access the user data in this block according to the local page mapping table.

In this embodiment, entries of each local page mapping table such as that shown in FIG. 8 are indexed by LPNs with each entry having one byte. This is for illustrative purposes only, and is not meant to be a limitation of the present invention. According to a variation of this embodiment, each entry of each local page mapping table may have more than one byte.

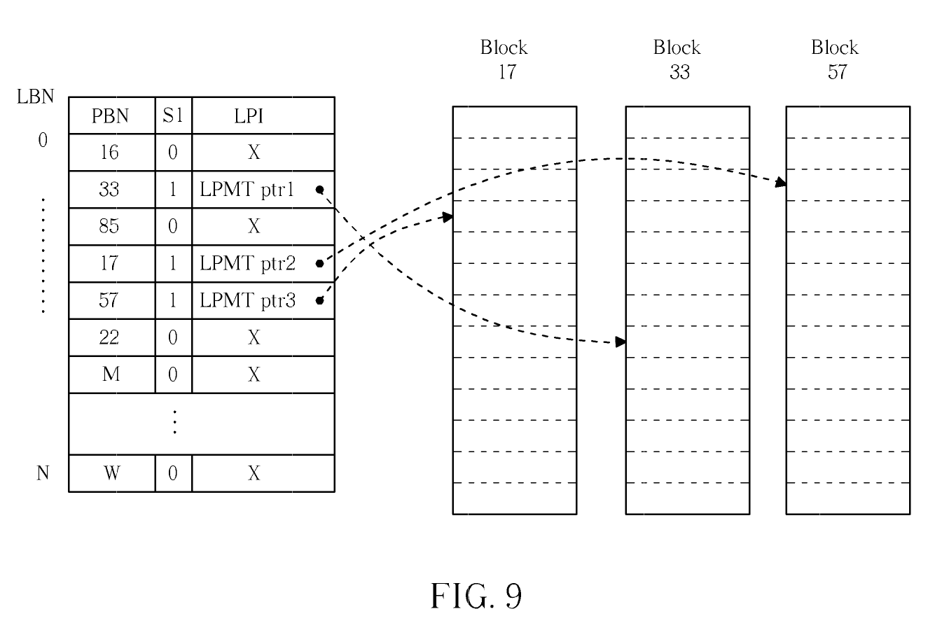

FIG. 9 illustrates an example of a plurality of latest page indexes embedded in a block mapping table and associated mapping relationships according to the embodiment shown in FIG. 8. In the block mapping table, the entries are indexed by LBNs. As shown in FIG. 9, the block mapping table represents respective relationships between LBNs and PBNs of the NV memory 120, where the flag S1 is similar to the flag S₁ shown in FIG. 3. For example, the logical value “1” of the flag S1 represents that the associated block is a random block, while the logical value “0” of the flag S1 represents that the associated block is a sequential block.

The third column “LPI” of the block mapping table shown in FIG. 9 represents the latest page indexes. Taking the second entry of the block mapping table as an example, the flag S1 has the logical value “1”, and the associated latest page index is a pointer LPMT ptr1 pointing to the latest page of Block 33. Similarly, regarding the fourth entry of the block mapping table, the flag S1 has the logical value “1”, and the associated latest page index is a pointer LPMT ptr2 pointing to the latest page of Block 57. In addition, regarding the fifth entry of the block mapping table, the flag S1 has the logical value “1”, and the associated latest page index is a pointer LPMT ptr3 pointing to the latest page of Block 17. Please note that the notation “X” in the block mapping table also stands for “Don't care” since the logical value “0” of the flag S1 represents that the associated block is a sequential block.

According to this embodiment, during random writing, the controller 110 often keeps the block mapping table updated. More particularly, the controller 110 updates a latest page index whenever the latest page of the associated block is changed. In addition, the local page mapping tables are eventually stored in the latest page of associated random mapping zones respectively, where each zone has at least one block. As a result, by utilizing a latest page index in a block mapping table such as that shown in FIG. 9, the controller 110 is capable of rapidly finding the local page mapping tables respectively stored in the latest page of the associated random mapping zones.

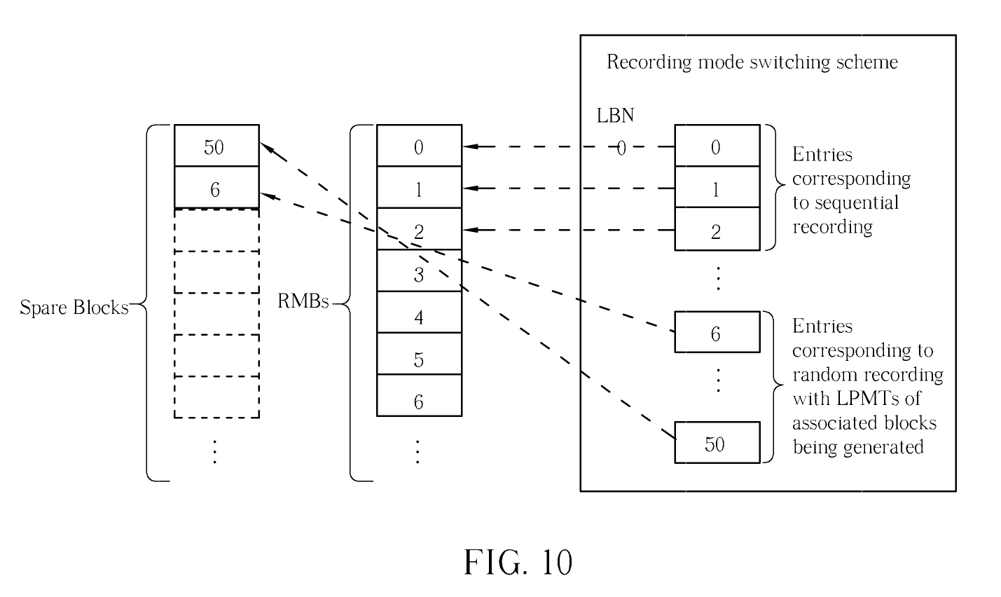

FIG. 10 illustrates an example of a writing mode switching scheme and associated mapping relationships according to the embodiment shown in FIG. 8. When it is determined that switching from sequential writing into random writing is required, the controller 110 can generate at least one local page mapping table immediately, and write pages into free areas of spare blocks. According to the writing mode switching scheme shown in FIG. 10, the starting entries corresponding to sequential writing have sequential mapping relationships, respectively. For example, the first few entries such as those corresponding to the LBNs of 0, 1 and 2 map to random mapping blocks (labeled “RMBs”) having the PBNs of 0, 1 and 2. In addition, the following entries corresponding to random writing have random mapping relationships, respectively. For example, two of the following entries map to spare blocks having the PBNs of 50 and 6, where the local page mapping tables of the associated zones are generated.

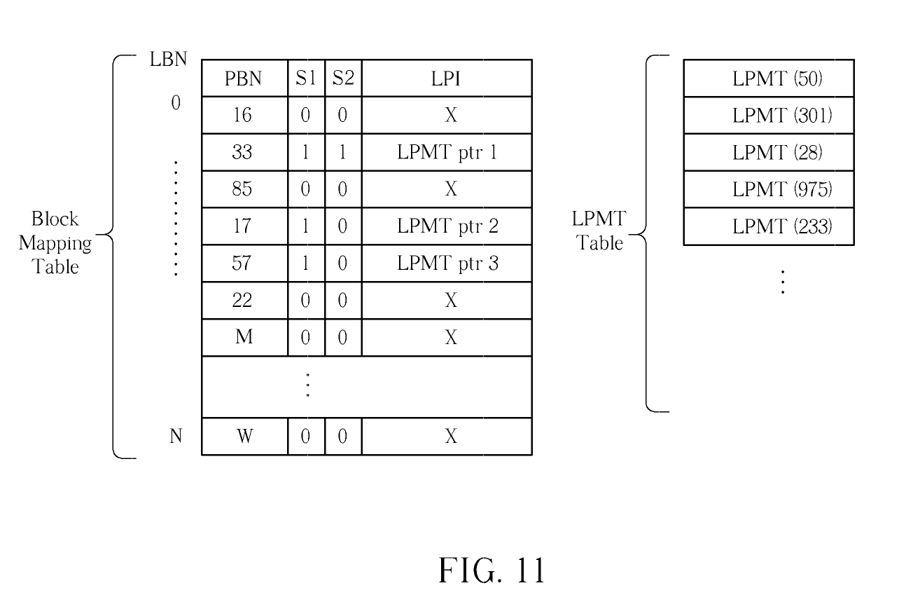

FIG. 11 illustrates an example of a plurality of latest page indexes embedded in a block mapping table and an associated LPMT table that may be positioned in one or more LPMT table blocks according to a variation of the embodiment shown in FIG. 8. Please note that a column of the flag S2 is inserted in the block mapping table. For example, the logical value “1” of the flag S2 represents that the associated block is stored in the NV memory 120, while the logical value “0” of the flag S2 represents that the associated block is stored in the volatile memory (e.g. the DRAM or the SRAM).

According to this variation, the controller 110 gathers all the local page mapping tables into the LPMT table, instead of storing the local page mapping tables in the latest page of respective blocks. For example, the LPMT table comprises local page mapping tables LPMT(50), LPMT(301), LPMT(28), LPMT(975), LPMT(233), etc. for blocks 301, 28, 975, 233, etc., respectively. Here, each of the local page mapping tables LPMT(50), LPMT(301), LPMT(28), LPMT(975), LPMT(233), etc. can be regarded as a sub-table or a partial table within the LPMT table. Similar descriptions for this variation are not repeated in detail here.

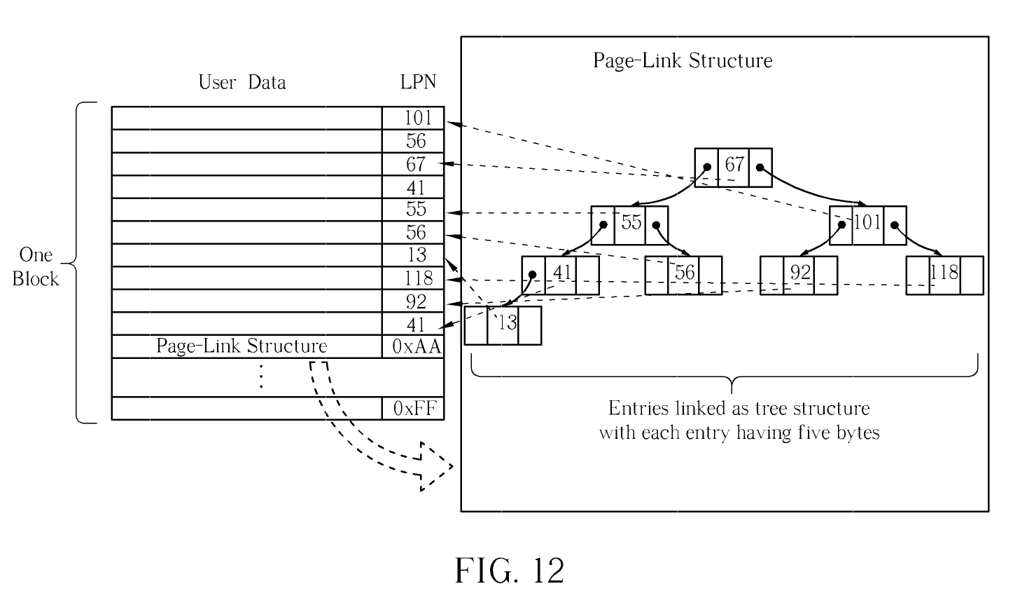

FIG. 12 illustrates an example of a page-link structure and associated mapping relationships according to another embodiment of the present invention, where this embodiment is a special case of the embodiment shown in FIG. 2. This embodiment is a variation of the embodiment shown in FIG. 8. More specifically, the aforementioned at least one local page mapping table regarding one random mapping zone is replaced by at least one page-link structure regarding one random mapping zone. That is, the page mapping information of this embodiment comprises at least one page-link structure regarding one random mapping zone, such as the page-link structure shown in FIG. 12. This is for illustrative purposes only, and is not meant to be a limitation of the present invention. According to a variation of this embodiment, the page mapping information comprises at least one page-link structure regarding two or more random mapping zones.

According to this embodiment, each entry of the page-link structure comprises information indicating whether at least one next entry exists or information indicating where the next entry is. For example, each entry of the page-link structure comprises five bytes. One of the five bytes is utilized for carrying the LPN of the associated page, two of the five bytes are utilized for carrying information indicating whether there exists a next entry of a first direction (e.g. the right direction in FIG. 12) or information indicating where the next entry is, and the remaining two of the five bytes are utilized for carrying information indicating whether there exists a next entry of a second direction (e.g. the left direction in FIG. 12) or information indicating where the next entry is. This is for illustrative purposes only, and is not meant to be a limitation of the present invention. According to a variation of this embodiment, each entry of the page-link structure may comprise more or less than five bytes.

As a result, the entries of the page-link structure are linked as a tree structure.

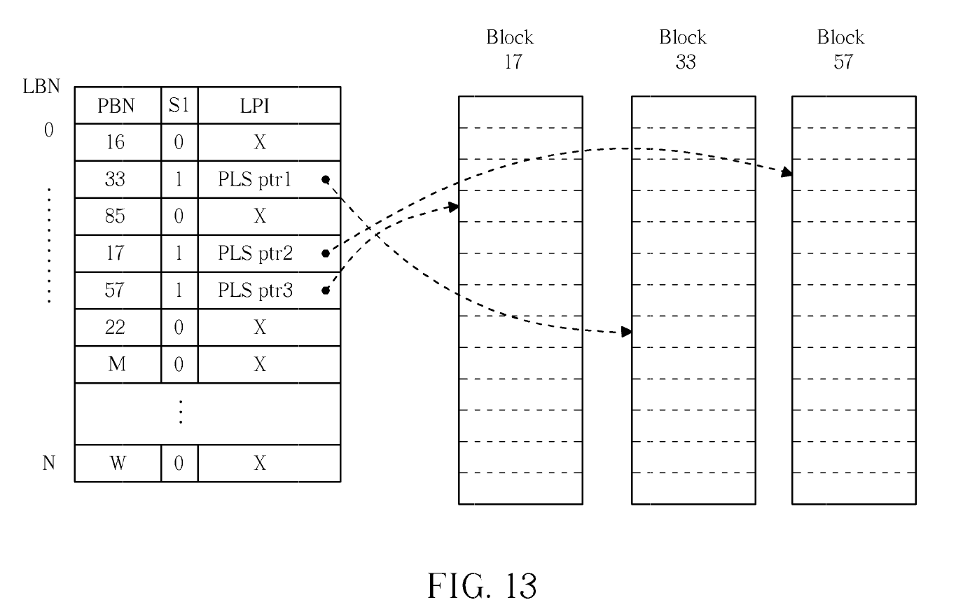

FIG. 13 illustrates an example of a plurality of latest page indexes embedded in a block mapping table and associated mapping relationships according to the embodiment shown in FIG. 12. In response to the differences between the embodiment shown in FIG. 12 and the embodiment shown in FIG. 8, the pointers LPMT ptr1, LPMT ptr2, and LPMT ptr3 mentioned above are respectively renamed as the pointers PLS ptr1, PLS ptr2, and PLS ptr3 since PLS stands for “page-link structure”. Similar descriptions for this embodiment are not repeated in detail here.

In contrast to the related art, the present invention method and apparatus are capable of generating one or more small sized mapping tables according to the page mapping information mentioned above for random writing. Therefore, the access to the NV memory is much faster.

It is an advantage of the present invention that the present invention method and apparatus can achieve high performance during full range random access by using the page mapping information mentioned above.

It is another advantage of the present invention that the present invention method and apparatus are suitable for being applied to server systems and systems under full range long term test.

Those skilled in the art will readily observe that numerous modifications and alterations of the device and method may be made while retaining the teachings of the invention.

What is claimed is:

1. A method for performing random writing on a non-volatile (NV) memory, comprising:
writing page mapping information regarding a portion of a full range of addresses of the NV memory and providing at least one page mapping table corresponding to a predetermined size of the NV memory, wherein the page mapping information represents at least a relationship between a logical page number and a physical page number; and
accessing the NV memory according to at least a portion of the page mapping information.

2. The method of claim 1, wherein the page mapping information comprises a first set of entries, and each entry of the first set of entries comprises information indicating whether a next entry exists or information indicating where the next entry is.

3. The method of claim 2, wherein the page mapping information comprises a random write page mapping table comprising the first set of entries.

4. The method of claim 2, wherein the page mapping information comprises at least one link chain, and one of the at least one link chain comprises at least a portion of the first set of entries.

5. The method of claim 4, wherein the at least one link chain comprises a plurality of link chains; and in one or more free areas, pages of a same block are linked together to form one of the link chains.

6. The method of claim 4, wherein the at least one link chain comprises a plurality of link chains; in one or more free areas, pages of a same group block are linked together to form one of the link chains; and the group block is a unit representing a group of blocks.

7. The method of claim 1, wherein the step of writing the page mapping information regarding the portion of the full range of addresses of the NV memory further comprises:
selectively writing at least a portion of the page mapping information in one or more pages of at least one block of the NV memory according to some other pages of the block.

8. The method of claim 7, wherein the portion of the page mapping information comprises a local page mapping table regarding one or more random mapping zones.

9. The method of claim 8, wherein the step of writing the page mapping information regarding the portion of the full range of addresses of the NV memory further comprises:
selectively writing/caching one or more entries of the local page mapping table in a volatile memory.

10. The method of claim 7, wherein the portion of the page mapping information comprises a page-link structure regarding one or more random mapping zones.

11. The method of claim 10, wherein each entry of the page-link structure comprises information indicating whether at least one next entry exists or information indicating where the next entry is.

12. The method of claim 10, wherein the step of writing the page mapping information regarding the portion of the full range of addresses of the NV memory further comprises:
selectively writing/caching one or more entries of the page-link structure in a volatile memory.

13. The method of claim 1, wherein the step of writing the page mapping information regarding the portion of the full range of addresses of the NV memory further comprises:
selectively writing the page mapping information in a volatile memory or the NV memory.

14. An apparatus for performing random writing on a non-volatile (NV) memory, comprising:
a controller arranged to perform the random writing; and
a program code, at least a portion of which is embedded within the controller or received from outside the controller;
wherein the controller executing the program code writes page mapping information regarding a portion of a full range of addresses of the NV memory and provides, within one of the apparatus and the NV memory, at least one page mapping table corresponding to a predetermined size, wherein the page mapping information represents at least a relationship between a logical page number and a physical page number; and the controller executing the program code accesses the NV memory according to at least a portion of the page mapping information.

15. The apparatus of claim 14, wherein the page mapping information comprises a first set of entries, and each entry of the first set of entries comprises information indicating whether a next entry exists or information indicating where the next entry is.

16. The apparatus of claim 15, wherein the page mapping information comprises a random write page mapping table comprising the first set of entries.

17. The apparatus of claim 15, wherein the page mapping information comprises at least one link chain, and one of the at least one link chain comprises at least a portion of the first set of entries.

18. The apparatus of claim 17, wherein the at least one link chain comprises a plurality of link chains; and in one or more free areas, pages of a same block are linked together to form one of the link chains.

19. The apparatus of claim 17, wherein the at least one link chain comprises a plurality of link chains; in one or more free areas, pages of a same group block are linked together to form one of the link chains; and the group block is a unit representing a group of blocks.

20. The apparatus of claim 14, wherein the controller executing the program code selectively writes at least a portion of the page mapping information in one or more pages of at least one block of the NV memory according to some other pages of the block.

21. The apparatus of claim 20, wherein the portion of the page mapping information comprises a local page mapping table regarding one or more random mapping zones.

22. The apparatus of claim 21, wherein the controller executing the program code selectively writes/caches one or more entries of the local page mapping table in a volatile memory.

23. The apparatus of claim 20, wherein the portion of the page mapping information comprises a page-link structure regarding one or more random mapping zones.

24. The apparatus of claim 23, wherein each entry of the page-link structure comprises information indicating whether at least one next entry exists or information indicating where the next entry is.

25. The apparatus of claim 23, wherein the controller executing the program code selectively writes/caches one or more entries of the page-link structure in a volatile memory.
